(19) United States
(12) Patent Application Publication
(10) Pub. No.: US 2018/0363322 A1
(43) Pub. Date: Dec. 20, 2018

(54) PUSH-PULL PASSAGE LOCK HOUSING

(71) Applicant: CMECH (GUANGZHOU) LTD., Guangzhou (CN)

(72) Inventor: Jia Sen Qiu, Guangzhou (CN)

(21) Appl. No.: 15/796,352

(22) Filed: Oct. 27, 2017

(30) Foreign Application Priority Data
Jun. 19, 2017 (CN) 201720717217.3

(51) Int. Cl. E05B 9/08; E05B 9/02

(52) U.S. Cl. CPC E05B 9/08; E05B 9/02

(57) ABSTRACT

A push-pull passage lock housing comprises upper and lower housings, and first and second connecting components. The upper and lower housings are connected to form a housing with a middle protuberance. The first connecting component is sleeved on the housing and located at one side of the protuberance, while the second connecting component is sleeved on the housing and located at the other side of the protuberance. The first and second connecting components are fastened together. The push-pull passage lock housing facilitates installation and improves assembly efficiency.

### CROSS-REFERENCE TO RELATED APPLICATIONS

This application claims priority to Chinese Patent Application No. 201720717217.3, filed Jun. 19, 2017, which is herein incorporated by reference in its entirety.

### FIELD OF THE INVENTION

This invention relates to a push-pull passage lock housing having simplified assembly and installation on a door.

### BACKGROUND OF THE INVENTION

In the prior art, there are many kinds of door locks, among which a push-pull passage lock is common and widely used. The push-pull passage lock has various structures, generally, it comprises a latch plunger or bolt, a sliding frame connected to the latch bolt and a cam configured inside the sliding frame, wherein the cam rotates and drives the sliding frame to rotate, whereby the latch bolt connected to the sliding frame is driven to retract. A reset spring is arranged to reset the sliding frame. This structure is complicated and has many components, thus it is difficult to assemble. In addition, the failure of the reset spring is likely to occur after a long-term service, and then the latch bolt cannot be inserted into the corresponding hole in the door frame any longer.

FIG. 1 shows a prior art door lock comprising handles 1, at least one lever 2, at least one rotating block 3, a slipping block 4, a latch bolt or plunger 5, and a reset spring 6 for resetting the latch bolt, wherein the lever 2, the rotating block 3 and the slipping block 4 are located inside a housing 7, and the lever 2 and the rotating block 3 both being hinged to the housing 7. One end of the lever 2 is connected to the handle and the other end is adjacent to the rotating block 3. One end of the slipping block 4 is connected to the latch bolt 5 and the other end is adjacent to the rotating block 3. Thus, the lever 2 rotates and drives the rotating block 1 to rotate, whereby the rotating block 3 contacts the slipping block 4 and pushes it up. However, it is still a problem to design a housing which can facilitate installation and improve assembly efficiency and accuracy.

### SUMMARY OF THE INVENTION

The present invention provides a push-pull passage lock housing which facilitates installation and improves assembly efficiency.

The present invention provides a technical solution as follows.

A push-pull passage lock housing comprises an upper housing, a lower housing, a first connecting component and a second connecting component, wherein the upper housing and the lower housing are connected to form a housing, and the housing protrudes in its middle to form a protuberance. The first connecting component is sleeved on the housing and is located at one side of the protuberance, and the first connecting component and second connecting component are fastened by screws to each other.

A guide pillar is configured in the lower housing, and a guide hole mated with the guide pillar is configured in the upper housing.

The first connecting component and the second connecting component both comprise a sleeve and a flange configured at one end of the sleeve, wherein the flange of the first connecting component is provided with mounting holes, the flange of the second connecting component is provided with screw holes, and the screws are passed through the mounting holes and are in threaded connection with the screw holes.

The housing is configured with a mounting slot where the screw is arranged.

A first receiving chamber is configured in the lower housing for installing a lever, and the lever can rotate within the first receiving chamber.

The upper housing and the lower housing connect at a connect surface which is in parallel with a direction in which the lever rotates.

Limiting stoppers for restricting the rotation angle of the lever are arranged at the two sidewalls of the first receiving chamber respectively.

A limit chamber is configured in the upper housing to prevent the lever from moving in a vertical direction.

By applying the above-mentioned technical solution, the invention has achieved the following benefits:
(1) The push-pull passage lock housing formed by an upper housing and a lower housing, and the housing is fastened by a first connecting component and a second connecting component sleeved on it. Such push-pull passage lock housing greatly simplifies the assembly procedures, and improves the assembly efficiency and accuracy.
(2) The upper housing and the lower housing can be placed in position and connected through the cooperation between the guide pillar and the guide hole.
(3) A limit chamber is configured in the upper housing to prevent the lever from moving in a vertical direction.
(4) Limiting stoppers are arranged at the two sidewalls of the first receiving chamber respectively to restrict the lever to rotate within a certain angle.

### BRIEF DESCRIPTION OF THE DRAWINGS

FIG. 1 is a sectional view of a prior art push-pull passage lock, as discussed in the Background.

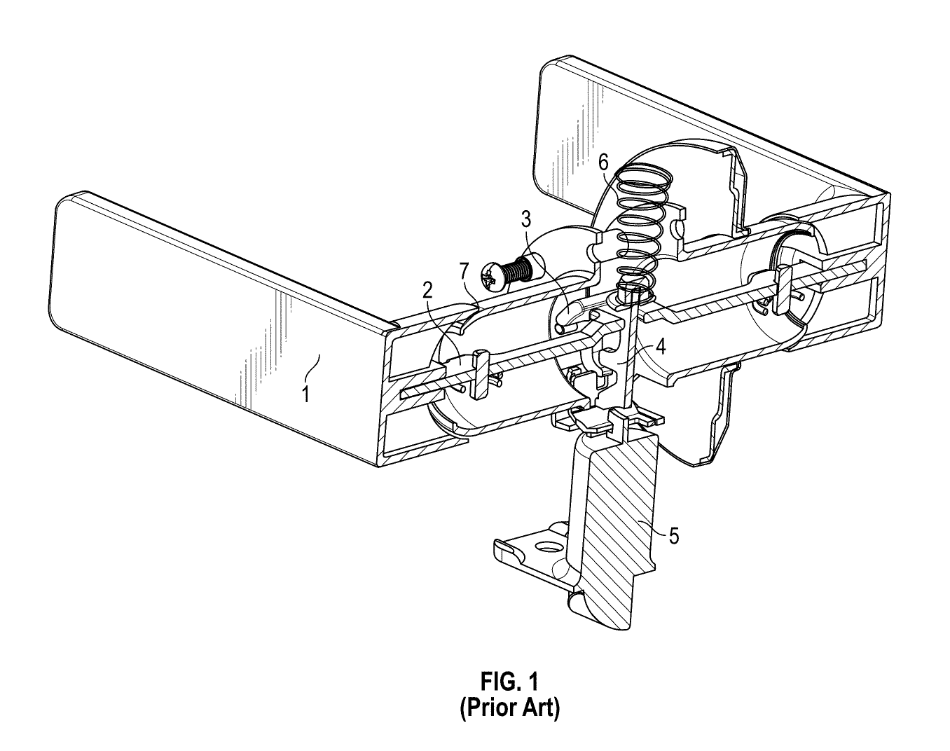

FIG. 2 is a perspective view of the push-pull door lock having the housing of the present invention.

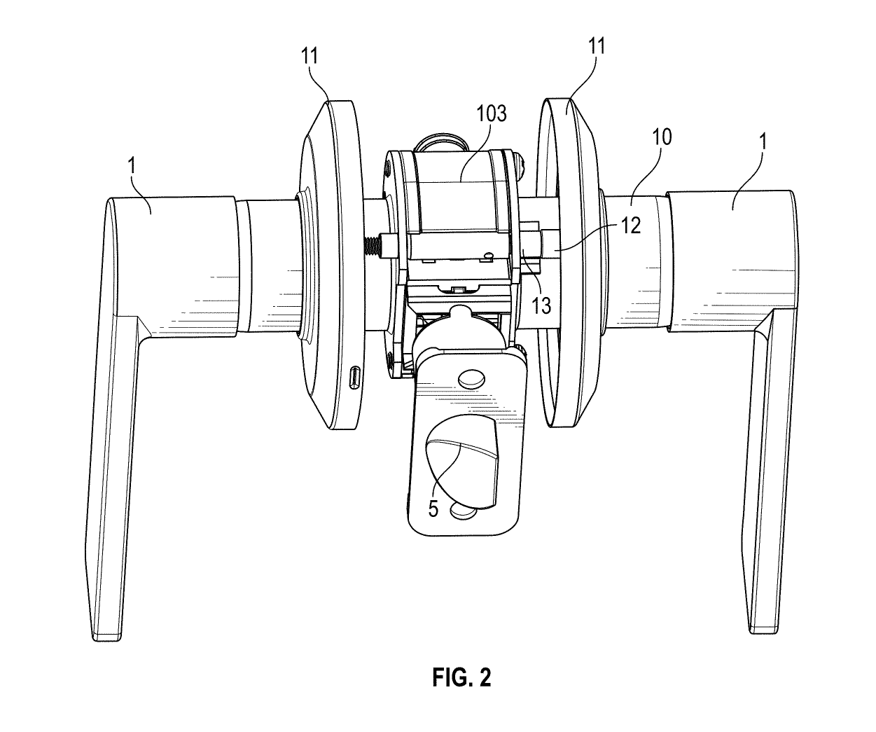

FIG. 3 is an exploded view of the push-pull door lock shown in FIG. 2.

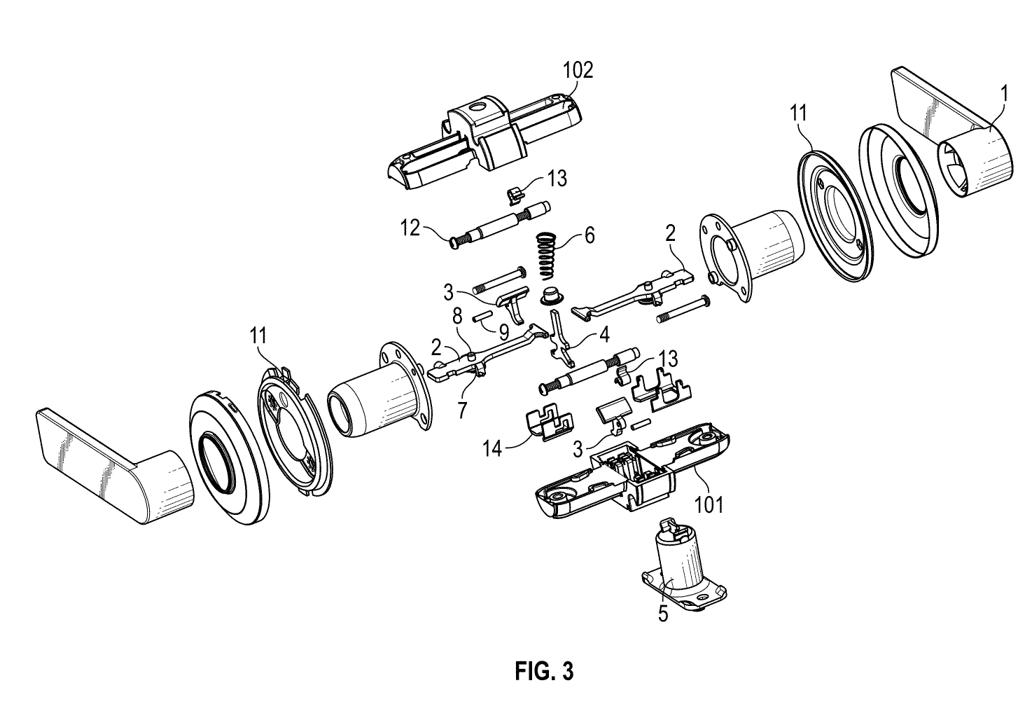

FIG. 4 is a perspective view of a push-pull passage lock housing according to the invention.

FIG. 5 is a partially exploded view of a push-pull passage lock housing according to the invention.

FIG. 6 is a perspective view of an upper housing of a push-pull passage lock housing according to the invention.

FIG. 7 is a perspective view of a lower housing of a push-pull passage lock housing according to the invention.

### DETAILED DESCRIPTION OF THE PREFERRED EMBODIMENTS

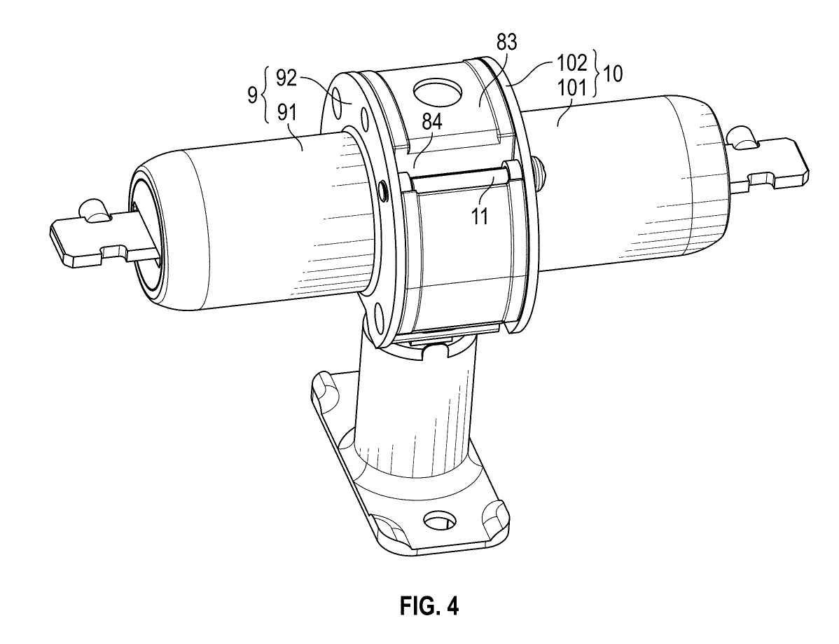

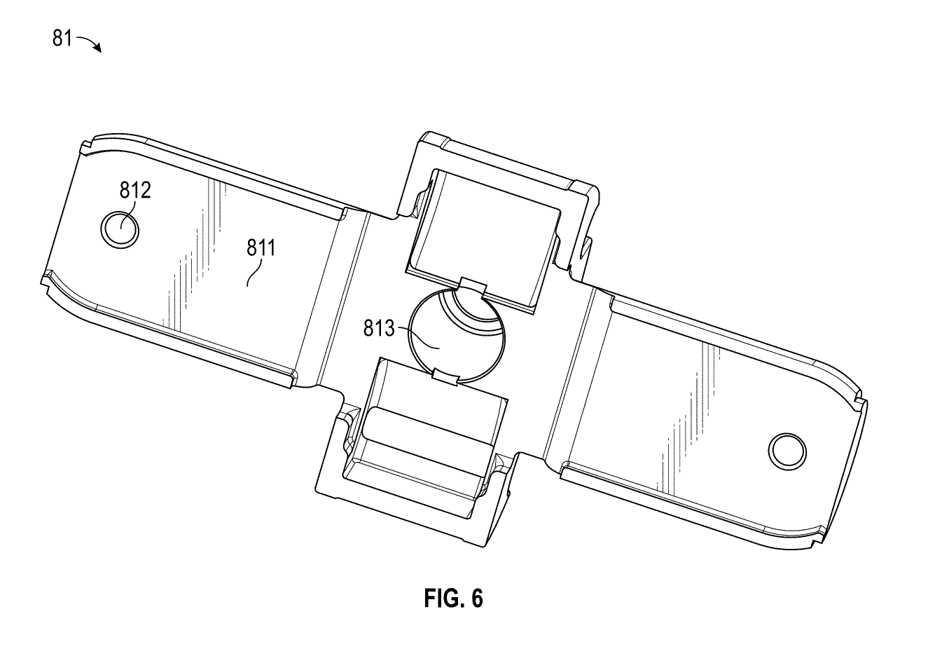

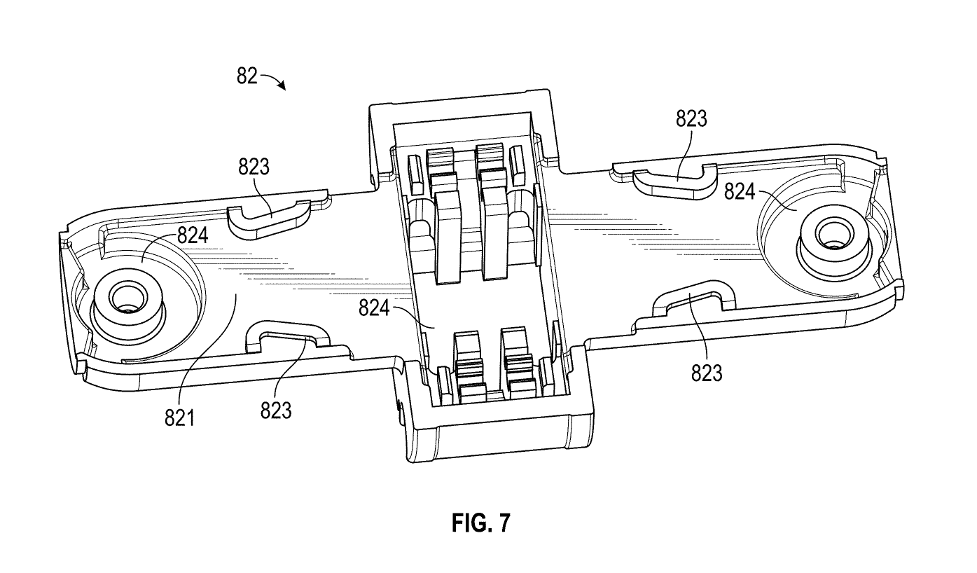

As shown in FIGS. 4-7, this invention provides a push-pull passage lock housing comprising an upper housing 81, a lower housing 82, a first connecting component 9 and a second connecting component 10, wherein the upper housing 81 and the lower housing 82 are connected to form a housing 8, and the housing 8 protrudes in its middle to form a protuberance 83. The first connecting component 9 is sleeved on the housing 8 and is located at one side of the protuberance 83, while the second connecting component 10 is sleeved on the housing 8 is located at one side of the protuberance 83, while the second connecting component 10 is sleeved on the housing 8 and is located at the other side of the prominence 83. The first connecting component 9 and second connecting component 10 are fastened to east other by screws 11. During assembly, the first connecting component 9 and the second connecting component 10 are sleeved on the housing 8 respectively, after the upper housing 81 and the lower housing 82 are aligned, and then the first connecting component 9 and the second connecting component 10 are fastened, which greatly simplifies the assembly procedures and improves the assembly efficiency and accuracy.

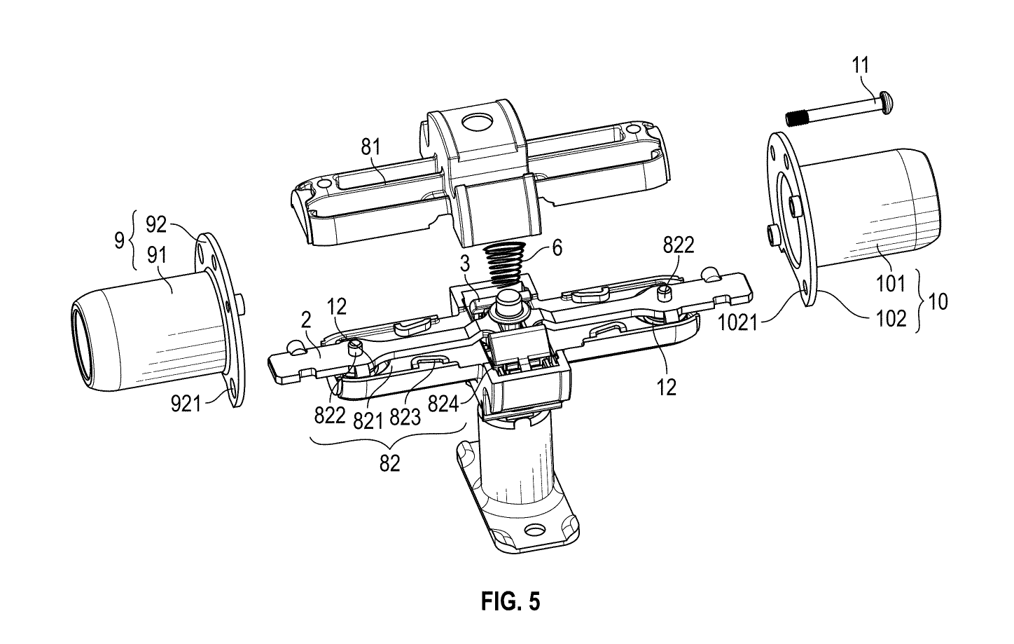

As shown in FIGS. 5-7, the housing 8 comprises the upper housing 81 and the lower housing 82, wherein a first receiving chamber 821 is configured in the lower housing 82 for installing a lever 2, and the level 2 can rotate within the first receiving chamber 821. A limit chamber 811 is configured in the upper housing 81 to prevent the lever 2 from moving in a vertical direction. A guide pillar 822 is configured in the first receiving chamber 821, and a guide hole 812 mated with the guide pillar 822 is configured in the limit chamber 811. The lever 2 is installed on the guide pillar 822 and can rotate around the pillar 822. A torsional spring 12 is fastened between the lever 2 and the lower housing 82, is seated in a recess or well 824 in the lower housing, and is sleeved on the guide pillar 822. Limiting stoppers 823 for restricting the rotation angle of lever 2 are arranged at the two sidewalls of the first receiving chamber 821 respectively, so as to prevent a failure of the reset spring 6 due to its super compression in case that the rotation angle of the lever 2 is too large.

The upper housing 81 and the lower housing 82 connect at connection surface which is in parallel with a direction in which the lever 2 rotates, bringing convenience to the assembly. A second receiving chamber 824 for receiving the rotating block and the slipping block 4 is configured in a protruding part of the lower housing 82, while a third receiving chamber 813 for installing the compressed reset spring 6 is configured at a protruding part of the upper housing 81, and the second receiving chamber 824 is disposed opposite to the third receiving chamber 813.

As shown in FIGS. 4 and 5, the first connecting component 9 comprises a hollow cylindrical sleeve 91 and a flange 92 configured at one end of the sleeve 91, wherein the flange 92 of the first connecting component 9 is provided with mounting holes 921. The second connecting component 10 also comprises a hollow cylindrical sleeve 101 and a flange 102 configured at one end of the sleeve 101, wherein the flange 102 of the second connecting component 10 is provided with screw holes 1021. Screws 11 pass through the holes 1021 and are in threaded connection with the screw holes 921, so as to tighten the housing. The housing is configured with a mounting slot 1121 where the screw is arranged.

The push-pull passage lock housing of the present invention has a simple structure and is convenient for the assembly. During the assembly, the upper housing 81 and the lower housing 82 are placed in position and connected through the cooperation between the guide pillar 822 and the guide hole 812. Then the first connecting component 9 and the second connecting component 10 are sleeved at the two sides of the protuberance of the housing respectively and are fastened by the screws 11, thereby the push-pull passage lock housing is assembled. During the disassembly, the whole housing 81, 82 can be disassembled just by removing the screws 11. Therefore, the push-pull passage lock housing of this invention greatly simplifies the assembly and disassembly procedures, improves the assembly efficiency and saves the resources and labor cost.

The push-pull door handle lock assembly of the present invention is further described in concurrently filed application Ser. No. 15/796,102, entitled PUSH-PULL PASSAGE LOCK MOUNTING DEVICE ADAPTED TO DOORS IN VARIOUS SIZES (docket P12347US00) and Ser. No. 15/796,550, entitled PUSH-PULL PASSAGE LOCK (docket P12349US00), which are incorporated by reference herein in their entireties.

It should be appreciated that the embodiment described hereinbefore is merely preferred embodiment of the present invention and not for purposes of any restrictions or limitations on the invention. Therefore, any simple amendments, equivalent variants and modifications to above embodiments according to the technical essence of the present invention, without departing from the technical solution of the present invention, should be incorporated into ambit of claims of the present invention.

What is claimed is:

1. A push-pull passage lock housing, comprising;
an upper housing;
a lower housing;
a first connecting component and a second connecting component;
wherein the upper housing and the lower housing are connected to form a housing, and the housing protrudes in its middle to form a protuberance;
the first connecting component and second connecting component being fastened to each other.

2. A push-pull passage lock housing according to claim 1, further comprising a guide pillar in the lower housing, and a guide hole mated with the guide pillar in the upper housing.

3. A push-pull passage lock housing according to claim 2, wherein the first connecting component and the second connecting component are fastened by screws.

4. A push-pull passage lock housing according to claim 3, wherein the first connecting component and the second connecting component both comprise a sleeve and a flange configured at one end of the sleeve; the flange of the first connecting component is provided with mounting holes, the flange of the second connecting component is provided with screw holes; and screws are passed through the screw holes and are in threaded connection with the mounting holes.

5. A push-pull passage lock housing according to claim 3, wherein the housing is configured with a mounting slot where the screw is arranged.

6. A push-pull passage lock housing according to claim 1, wherein a first receiving chamber is configured in the lower housing for installing a lever, and the lever rotates within the first receiving chamber.

7. A push-pull passage lock housing according to claim 6, wherein the upper housing and the lower housing connect at a connection surface which is in parallel with a direction in which the lever rotates.

8. A push-pull passage lock housing according to claim 6, further comprising limiting stoppers arranged at two sidewalls of the first receiving chamber for restricting rotation angle of the lever.

9. A push-pull passage lock housing according to claim 6, further comprising a limit chamber in the upper housing to prevent the lever from moving in a vertical direction.

10. A push-pull passage door lock, comprising:
a retractable plunger;
interior and exterior levers to actuate the plunger;
interior and exterior handles connected to the interior and exterior levers, respectively, to actuate the levers when the handles are pushed and pulled;
a pair of housings between which the levers are pivotally mounted;
interior and exterior connectors mounted on opposite ends of the housings to hold the housing together; and
fasteners securing the interior and exterior connectors together.

11. The push-pull passage door lock of claim 10 wherein each connector includes a cylindrical sleeve to fit over the housings and a radially extending flange, and the fasteners extend through the flanges.

12. The push-pull passage door lock of claim 11 wherein one of the housings include a stop to limit rotation of one of the levers.

13. The push-pull passage door lock of claim 11 further comprising interior and exterior guide pins mounted in the one of the housings, respectively, and upon which the interior and exterior levers are respectively mounted.

14. The push-pull passage door lock of claim 10 wherein the housings include slots through which the fasteners extend.

15. The push-pull passage door lock of claim 10 wherein the fasteners are screws.

16. The push-pull passage door lock of claim 10 wherein one of the housings includes a chamber for receiving the levers.

17. The push-pull passage door lock of claim 16 wherein the other of the housings restricts vertical movement of the levers.

18. A method of assembling a push-pull door handle, comprising:
pivotally mounting a pair of levers in opposite ends of a first housing;
enclosing the levers with a second housing; then
securing the first and second housings together with a pair of connectors mounted over the housings at opposite ends of the housings, with opposite ends of the levers extending beyond the connectors; and then
attaching a pair of handles to the ends of the levers for push and pull actuation of the levers.

19. The method of claim 18 further comprising fastening the connectors together.

20. The method of claim 18 further comprising operatively connecting a retractable plunger to one of the housings and to the levers for retraction when either of the handles is pushed or pulled.
